(19) United States
(12) Patent Application Publication
(10) Pub. No.: US 2006/0286218 A1
(43) Pub. Date: Dec. 21, 2006

(54) Substantially soluble display medium

(76) Inventor: David Salzman, Stratham, NH (US)

Correspondence Address: LAHIVE & COCKFIELD, 28 STATE STREET, BOSTON, MA, 02109, US

(21) Appl. No.: 11/432,860

(22) Filed: May 12, 2006

Related U.S. Application Data
(60) Provisional application No. 60/680,726, filed on May 12, 2005.
(60) Provisional application No. 60/699,467, filed on Jul. 15, 2005.

(51) Int. Cl. A23B 7/148

(52) U.S. Cl. 426/106

(57) ABSTRACT

The present invention is related to substantially soluble display media. Such display media can be used, e.g., to garnish a consumable liquid product. The present invention is also directed to methods for making and using the substantially soluble display media described herein.

### RELATED APPLICATIONS

This application relates to and claims priority to U.S. Provisional Application Ser. No. 60/680,726, filed May 12, 2005 and U.S. Provisional Application Ser. No. 60/699,467, filed Jul. 15, 2005. The contents of these applications are hereby incorporated by this reference in their entireties.

### BACKGROUND

Packaging material bearing decorative marks (e.g., company logos or trademarks) are common means of marketing a product. However, this form of advertising is limited because the impact it has on the consumer lasts only as long as the product remains in the package. Thus, once removed, the packaging is no longer effective advertising. Numerous other devices (besides the packaging material or the product itself) are also available to assist in the effective marketing of a product. Such devices well known in the art include coasters, insulating barriers fitted about and around the beverage container, and stirring sticks. Although each of these devices possess the ability for marketing, there are limitations associated with each device, the most apparent of which is the interference of the actual use of the device with its continuous use as a display medium.

### SUMMARY OF THE INVENTION

The present invention is based, at least in part, on a display medium that acts as a garnish on a consumable liquid product. Without wishing to be bound by any particular theory, it is believed that the substantially soluble display media of the present invention provide extended and basically uninterrupted display opportunities. Accordingly, the present invention relates to methods and compounds used to garnish a consumable liquid product. More specifically, the present invention relates to a substantially soluble display medium having formed thereon a decorative feature.

In accordance with the present invention, a method for garnishing a beverage, soup, chowder, and other like drinkable or edible liquid is disclosed. In another embodiment of the present invention, a method for forming a substantially soluble display medium is disclosed. The substantially soluble display medium can be diaphanous or not. In practice, the substantially soluble display medium is formed of an edible quasi-transparent component, e.g., a substantially water soluble edible composition. On a surface of the substantially soluble display medium is formed, using an edible non-transparent component, a message, a logo, a digital image, a pattern, a color, multiple colors, or one or more other like decorative features. The substantially soluble display medium with the decorative feature formed thereon is suitable for placement on a surface of a consumable liquid product, e.g., a beverage, soup, chowder, and other like drinkable or edible liquid held in a container to provide the consumable liquid product with an edible decorative display feature. In some embodiments, placement of the substantially soluble display medium with the decorative feature formed thereon on the surface of the consumable liquid product causes the quasi-transparent component to take on the characteristics of the liquid, leaving the decorative feature exposed on a surface of the consumable liquid product.

Those skilled in the art will appreciate that the substantially soluble display medium and the decorative feature formed thereon can be placed in direct contact with a surface of the consumable liquid product, e.g., the beverage, soup, chowder, and other like drinkable or edible liquid. Additionally or alternatively, the substantially soluble display medium and the decorative feature formed thereon can be placed in indirect contact with the surface of the consumable liquid product. For example, indirect contact may result from placement of the substantially soluble display medium with the edible decorative feature formed thereon on a surface of a layer of foamed milk, a surface of a layer whipped cream, a surface of a layer of ice cream, a surface of a layer of caramel, a surface of a layer of hot fudge, a surface of a layer of butterscotch, or other like edible layer used to garnish, or enhance the taste, or appearance of a beverage, soup, chowder, and other like drinkable or edible liquid.

### BRIEF DESCRIPTION OF THE DRAWINGS

FIG. 1 is a flow chart depicting an exemplary method for making and using the substantially soluble display media of the present invention.

FIG. 2 is a schematic representation of an exemplary decorative feature formed on a substantially soluble display medium according to the teachings of the present invention being placed in contact with the surface of a beverage.

FIG. 3 is a schematic representation of an exemplary decorative feature formed on a substantially soluble display medium according to the teachings of the present invention in contact with the surface of a beverage.

FIG. 4 is a schematic representation of an exemplary decorative feature formed on a substantially soluble display medium according to the teachings of the present invention in contact with the surface of soup.

FIG. 5 is a schematic representation of an exemplary system suitable for formation of a decorative feature on a substantially soluble display medium in accordance with the teachings of the present invention.

### DETAILED DESCRIPTION

The present invention is directed to methods and compositions used to garnish a consumable liquid product. More specifically, the present invention relates to a substantially soluble display medium having formed thereon a decorative feature. The decorative feature can be any feature described herein, such as a numeric character, a text character, a graphical image, a pattern, a single color, multiple colors or any combination thereof. The decorative feature is typically an edible non-transparent decorative feature that remains on the surface of a consumable liquid product held in a container when the substantially soluble display medium is placed on the surface thereof.

It is to be understood that, although specific terms are employed herein, they are used in a generic and descriptive sense only and not for purposes of limitation. However, so that the invention may be more readily understood, certain terms are first defined:

It is to be noted that the singular forms “a,” “an,” and “the” as used herein include “at least one” and “one or more” unless stated otherwise. Thus, for example, reference to “an additional agent” includes mixtures of two or more agents as well as a single agent, and the like.

As used herein, the term “substantially soluble” refers to the fact that the substantially soluble display media of the present invention will have the ability to dissolve at least partially in a solution under specific conditions. That is, substantially soluble display media includes display media that are completely soluble with or without heat or agitation. Additionally or alternatively, substantially soluble display media include display media which will dissolve slightly or slowly with or without agitation (e.g., stirring) or heat. Without wishing to be bound by any particular theory, it is believed that such slower solubility in display media can be beneficial, e.g., where ink may run slightly and/or where it is desirable to maintain the substantially soluble display media in the consumable liquid product for an extended period of time. It is to be understood that any range of solubility between the two examples listed (e.g., display media which dissolves fully and/or quickly with agitation) are meant to be encompassed by this invention.

As used herein, the term “consumable liquid product” refers to a food or beverage product that is at least partially in liquid form when consumed (e.g., eaten or drank). Consumable liquid products include products that are completely liquid, e.g., beer, products that are partially solid, e.g., soups, products that are partially or fully frozen, e.g., iced beverages, smoothies, milkshakes and/or ice cream, products that are emulsions or semi-solid, e.g., yogurt, whipped cream and/or condiments, and any mixtures thereof. Exemplary consumable liquid products include, but are not limited to beverages, soups, chowders, ice-cream, frozen beverages and other like drinkable or edible liquids, such as coffee, milkshakes, smoothies, malt-based beverages, non-alcoholic malt beverages, and other alcoholic and non-alcoholic beverages, soups, chowders, gumbo, and other like food stuffs served or servable in a container.

In some aspects, the present invention is directed to a substantially soluble display medium. As used herein, the term “substantially soluble display medium” refers to substantially soluble media capable of displaying a decorative feature. In some embodiments, the substantially soluble display medium is an edible quasi-transparent component having a selected shape and dimensionality. Display media can be imaged with a decorative feature or can remain un-imaged at the point of sale, e.g., to be imaged at a later time. Accordingly, the term “substantially soluble display medium” can include media that has been imaged with a decorative feature. Decorative features are generally edible non-transparent components. The term “quasi-transparent” refers to the property of the un-imaged display medium, or un-imaged portion of the substantially soluble display medium, which allows it to take on the characteristics of a consumable liquid product, e.g., the color and/or surface features of the product. The quasi-transparent component need not be transparent when not in direct or indirect contact with a consumable liquid product. For example, it may be visually translucent prior to garnishing. The term “non-transparent” refers to the property of the imaged portion of the substantially soluble display medium (i.e., the portion with the decorative feature), which allows it to at least partially conceal the characteristics of the consumable liquid product with its own characteristics, thus acting as a display.

In some embodiments, the substantially soluble display medium is buoyant. Without wishing to be bound by any particular theory, it is believed that a substantially soluble display medium with buoyancy can serve a number of purposes, including the maintenance of the substantially soluble display medium on the surface of the consumable liquid product and the slowing of the dissolution of the medium into the consumable liquid product. In some embodiments, the substantially soluble display medium is substantially buoyant. For example, a slight sinking of the substantially soluble display media can be acceptable in some embodiments, provided that the media is still able to display at least a portion of the original decorative feature. In some embodiments, the buoyancy of the substantially soluble display medium is based on its density. The density of a composition may be altered to enhance the buoyancy of the substantially soluble display medium without undue experimentation.

In other embodiments, the substantially soluble display medium of the present invention does not substantially absorb liquid, e.g., a liquid portion of the consumable liquid product. Without wishing to be bound by any particular theory, it is believed that low absorbency can be beneficial, e.g., in not distorting an image printed on a substantially soluble display medium.

In some embodiments, the substantially soluble display medium of the present invention has little or no taste. Having no taste may be desirable, for example, when a consumer does not want to alter the flavor of the consumable liquid product in any way. In some embodiments, a slight or moderate taste is acceptable. Having a slight or moderate taste may be acceptable, e.g., because the flavor of the consumable liquid product is intense enough to cover any taste from the substantially soluble display medium. In still other embodiments, the substantially soluble display medium will have a taste or flavor. Having a taste or flavor may be beneficial, e.g., where the consumer would like to add a flavoring or taste to a consumable liquid product.

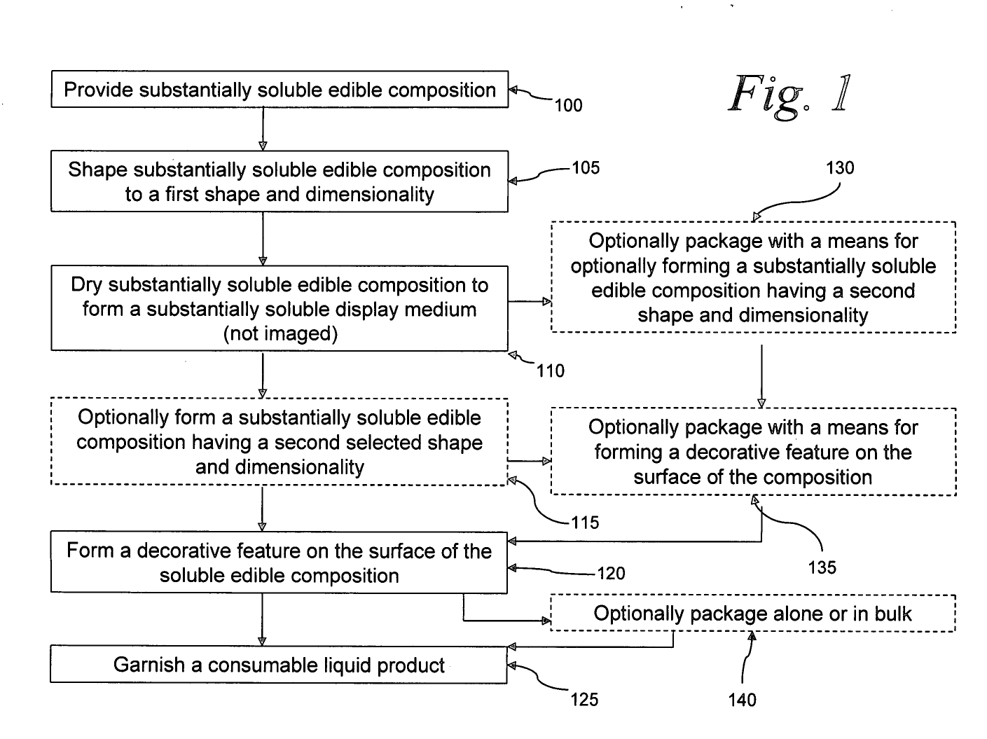

In other aspects, the present invention provides methods for manufacturing a substantially soluble display medium. Referring to FIG. 1, the method includes providing a substantially soluble edible composition 100; forming the substantially soluble edible composition into a first selected shape having a first dimensionality 105; and drying the first selected shape to form the substantially soluble display medium 110. The method can further comprise forming a selected decorative feature on a surface of the substantially soluble edible composition 120. The first shape can have any shape having a first dimensionality. In some embodiments, the first shape is a film or film-like structure.

The methods for drying used in connection with the present invention can be any known drying method. In some embodiments, the first selected shape is air dried at room temperature. In other embodiments, the first selected shape is dried using high temperature, vacuum, a stream of air or other means for more rapid drying. Drying can be for any period of time sufficient to dry the substantially soluble display medium of the present invention (e.g., to evaporate the majority of the excess water in the composition). Typical drying times are about 24-26 hours under normal air drying conditions. The skilled artisan would know that this drying time period would be effected by environmental conditions, such as temperature and humidity.

In some aspects, the present invention is also directed to garnishing a consumable liquid product with any of the substantially soluble display media described herein 125. In some embodiments, one or more optional steps may be included in the methods of the present invention. Exemplary optional steps include, but are not limited to, optionally forming the substantially soluble edible composition or the substantially soluble display medium into a second selected shape and dimensionality 115 and optionally packaging the product after any step for sale or other use 130, 135, 140. Forming a second selected shape may be accomplished by cutting, e.g., with scissors, a shaped punch or a cookie cutter. Packaging, e.g., in a kit, can also include a means for forming the substantially soluble display medium into a second selected shape and dimensionality 135 or a means for forming a decorative feature on the surface of the composition 140.

The substantially soluble edible composition typically includes an edible product capable of dissolution. It is to be understood that certain edible products must be cooked, dehydrated, dried, shredded, ground or otherwise processed before they are rendered capable of dissolution. Such edible products include, but are not limited to cellulose ethers and certain starches. The edible product is dissolved in a solution, e.g., an aqueous solution. In some embodiments, heat is needed to dissolve the edible product. The skilled artisan would be able to determine the amount of heat necessary, if any, based, for example, on the cloudiness or thickness/viscosity of the solution. Additional components to aid the texture, plasticity, buoyancy, absorbency, transparency or other property of the substantially edible component can also be added. Examples include, but are not limited to oils, e.g., vegetable oils, and glycerin. In some embodiments, altering the order of addition of any of the above mentioned components would not substantially effect the resulting the substantially soluble edible component.

In one illustrative embodiment of the present invention, the substantially soluble display medium is formed using a composition of cellulose ethers, such as METHOCEL® methylcellulose, ethylcellulose, propylcellulose, and hydroxycellulose, along with glycerin, cornstarch and water. METHOCEL® is available from the Dow Chemical Company of Midland, Mich. To form the substantially soluble display medium a portion of the water is heated to between about 177° F. and about 194° F. The cellulose ethers are added to the heated water until completely dissolved and an additional amount of water at room temperature is added to the heated water and the dissolved cellulose ethers. The glycerin and cornstarch are then added to the water and cellulose ethers composition and the entire composition is agitated for about twenty minutes. The heated and agitated composition is then spread across a cooling means to cool and dry for a selected time period.

In another illustrative embodiment of the present invention, the substantially soluble display medium is formed using a composition of certain starches, e.g., dehydrated potatoes, or other starches such as rice or corn starch, along with vegetable oil, water and optionally glycerin. In some embodiments, cellulose ethers are not used in the formulations of the present invention. To form the substantially soluble display medium a portion of the water is heated to between about 177° F. and about 194° F. The potatoes are added to the heated water until completely dissolved and an additional amount of water at room temperature is added to the heated water and the potatoes. The vegetable oil is then added to the potato/water composition and the entire composition is agitated for about twenty minutes. In some embodiments, glycerin is added to the composition prior to agitation. The heated and agitated composition is then spread across a cooling means to cool and dry for a selected time period.

Those skilled in the art will appreciate that a number of units of measure and ratios between ingredients are possible without departing from the scope of the present invention. For example, the amount of ingredients used can change according to the size and dimensionality of the substantially soluble display medium one chooses to form. For example, 18 ml of METHOCEL®, 1 ml of glycerin, one quarter teaspoon of cornstarch, and 8 ounces (approximately 237 ml) of water can be combined as described above to form a suitable display medium. In another example, potatoes, water and vegetable oil are combined in a ratio of 4:4:2 as described above to form a different suitable display medium. Any amounts that are suitable for producing a substantially soluble display medium may be used in conjunction with the present invention. Furthermore, the skilled artisan would understand that differing the ratio of ingredients may have an effect on the properties of the substantially soluble display medium, e.g., slightly increasing the amount of water used in production may lead to a thinner, more transparent or diaphanous display media, while dramatically increasing the amount of water may lead to a composition that is too thin to form a substantially soluble display medium of the present invention.

The cooling means can be any surface that will allow for the formation of a first selected shape of substantially soluble edible component having a first dimensionality. In one illustrative embodiment of the present invention, the cooling means is formed from parchment paper. The parchment paper is placed on a surface of a workstation and the heated and agitated compound is placed thereon. In turn, the parchment paper is placed on the surface of the heated agitated compound opposite the surface in contact with the parchment paper. The placement of the parchment paper in contact with the surface of the heated and agitated compound allows for the smoothing and distribution of the compound to attain a desired thickness, shape, and optionally flatness. The smoothing and distribution of the heated and agitated compound forming the substantially soluble display medium can be accomplished using a number of suitable means, including, but not limited to a spatula, a worker's hand, a rolling pin, a press, or other suitable means for forming the compound into a desired thickness and desired shape having a desired dimensionality. Once dried, the substantially soluble display medium is formed and can be partitioned into smaller segments, shapes, and sizes to suit ones needs. Those skilled in the art will appreciate that other suitable cooling means can include, but are not limited to sheets of glass, Plexiglas, parchment paper, sheets of aluminum foil, mylar, and the like.

The substantially soluble display medium of the present invention can be decoratively prepared with the edible non-soluble decorative feature at the point of sale of the consumable liquid product, for example, at any time prior to serving or preparation of a beverage, soup, chowder, and other like drinkable or edible liquid or, may be pre-prepared and pre-sold in any quantity with or without the edible non-soluble decorative feature formed thereon. For example, the substantially soluble display medium may be purchased in a store, via an online transaction, via a telephone transaction, via a facsimile transaction, or any other suitable transaction. That is, the substantially soluble display medium of the present invention is available pre-imaged with a decorative feature, or free of any decorative feature formed on a surface of the substantially soluble display medium. Having available for sale substantially soluble display media free of a decorative feature allows the purchaser to form any number of desired decorative features on a surface of any number of the edible soluble display media. Accordingly, the present invention is also directed to a kit comprising a substantially soluble display media and a means for placing a decorative feature thereon, e.g., an edible ink pen. The substantially soluble display medium of the present invention can take any number of shapes, for example, a circle, a rectangle, a square, a triangle, a flower, a tree, a gingerbread man, a bowtie, and the like.

In some aspects, the present invention is related to methods for garnishing a consumable liquid product. The methods can generally include selecting any substantially soluble display medium described herein, e.g., one having an edible quasi-transparent component having a selected shape and dimensionality and an edible non-transparent component imaged on a surface of the quasi-transparent component to form a decorative feature, and placing the substantially soluble display medium on a surface of the consumable liquid product. Additionally or alternatively, the method includes selecting a substantially soluble display medium of the present invention, forming a decorative feature on a surface of the substantially soluble display medium, e.g., by imprinting with a printer and/or by writing or drawing with an edible ink pen, and placing the substantially soluble display medium on a surface of the consumable liquid product. It is to be understood that the methods of the present invention include garnishing any consumable liquid product described herein with any of the substantially soluble display media described herein which includes any decorative feature.

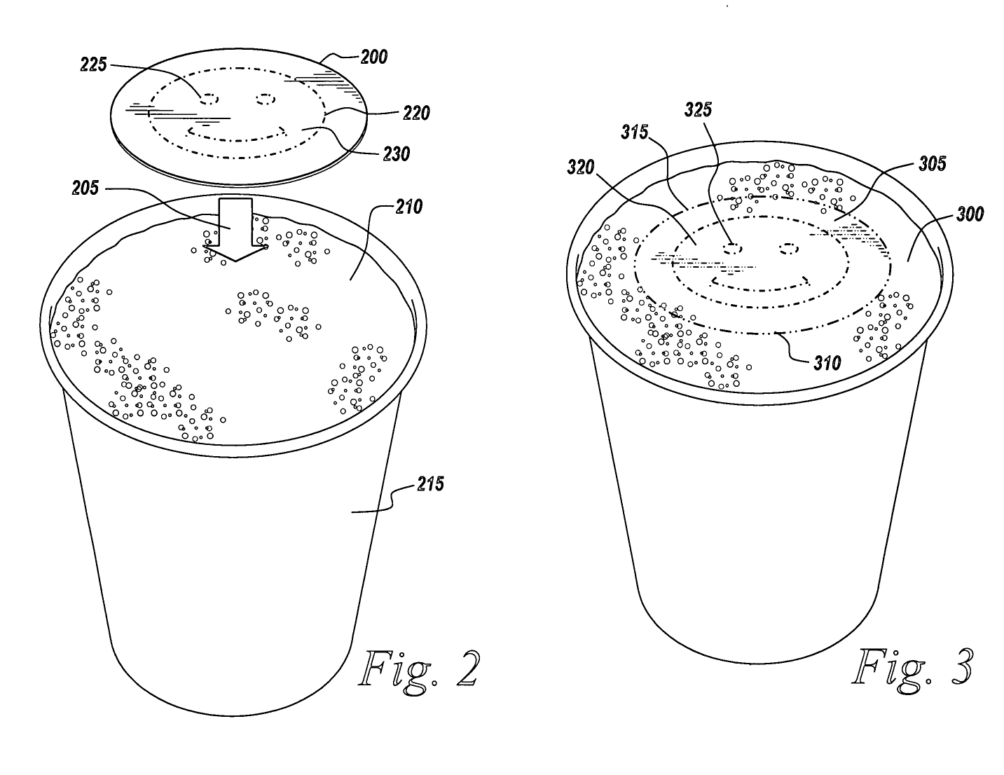

Referring to FIG. 2, a substantially soluble display medium 200 of the present invention can be added 205 to the surface of a beverage 210 held in a container 215. The beverage may be hot or cold, and include any of the consumable liquid products described herein. The substantially soluble display medium can have a decorative feature 220 formed thereupon. The decorative feature is non-limiting and can be any decorative feature described herein or any other decorative feature. The decorative feature can be one or more colors. For example, a portion of the decorative feature can be one color 225, and a different portion may be a second color 230. Any number of colors and mixtures thereof can be used for the decorative features of the present invention.

Referring to FIG. 3, once added to the beverage surface 300, the unprinted quasi-transparent component 305 of the display medium takes on the characteristics of the beverage surface (e.g., color, etc.). The visual blending of the quasi-transparent component of the substantially soluble display medium into the surface is represented by the dot-dashed line 310. The decorative feature 315 typically remains intact on the surface of the beverage. In some embodiments, different colors 320 and 325 in the decorative feature do not blend with each other, or bleed into the beverage. In other embodiments, the colors can somewhat bleed or blend.

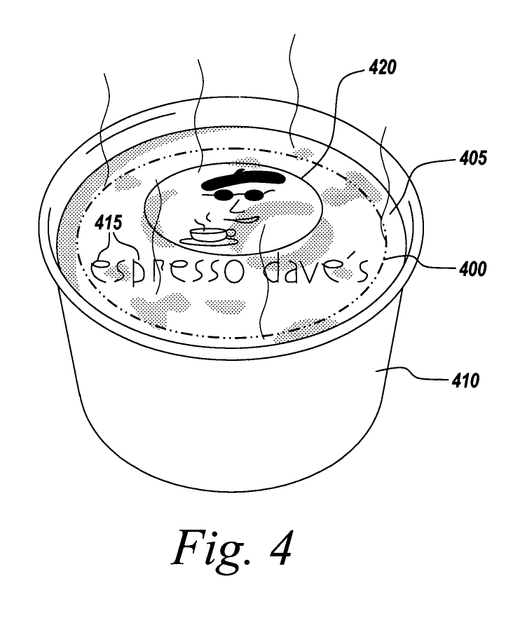

Referring to FIG. 4, a substantially soluble display medium 400 of the present invention can be added to the surface of a soup or chowder 405 held in a container 410. The substantially soluble display medium can have a decorative feature, e.g., a textual feature 415, a graphical feature 420 or both formed thereupon. The decorative feature is non-limiting and can be any decorative feature described herein or any other decorative feature. The decorative feature can be or include one or more colors.

Formation of the decorative feature on a surface of the substantially soluble display medium is accomplishable with a number of techniques and methodologies. In one method, the decorative feature is formed with a computer system. The computer system can, in some embodiments, include a display device, input devices such as a keyboard and a mouse, a CPU, a storage device holding a program suitable for forming or creating a computer generated image and an image-forming device, such as an inkjet printer for use in forming the decorative feature on the substantially soluble display medium.

In this manner, in some embodiments a user of a computer system can create a decorative feature using a suitable program stored on the storage device and instruct the computer system to image the decorative feature using the image-forming device onto the substantially soluble display medium. The image-forming device can then image the decorative feature onto a surface of the substantially soluble display medium using an edible ink, for example, food coloring or other suitable edible ink described herein, such as colored water, colored propylene glycol, colored or uncolored alcohol, and FD&C colors.

In some embodiments, the computer system can include an optical scanner capable of reading text or illustrations printed on a medium and translate the information into a form the computer system understands. In this manner, a user can scan a desired decorative feature using the optical scanner in to the computer system and have the computer system image the decorative feature onto the substantially soluble display medium using the image-forming device.

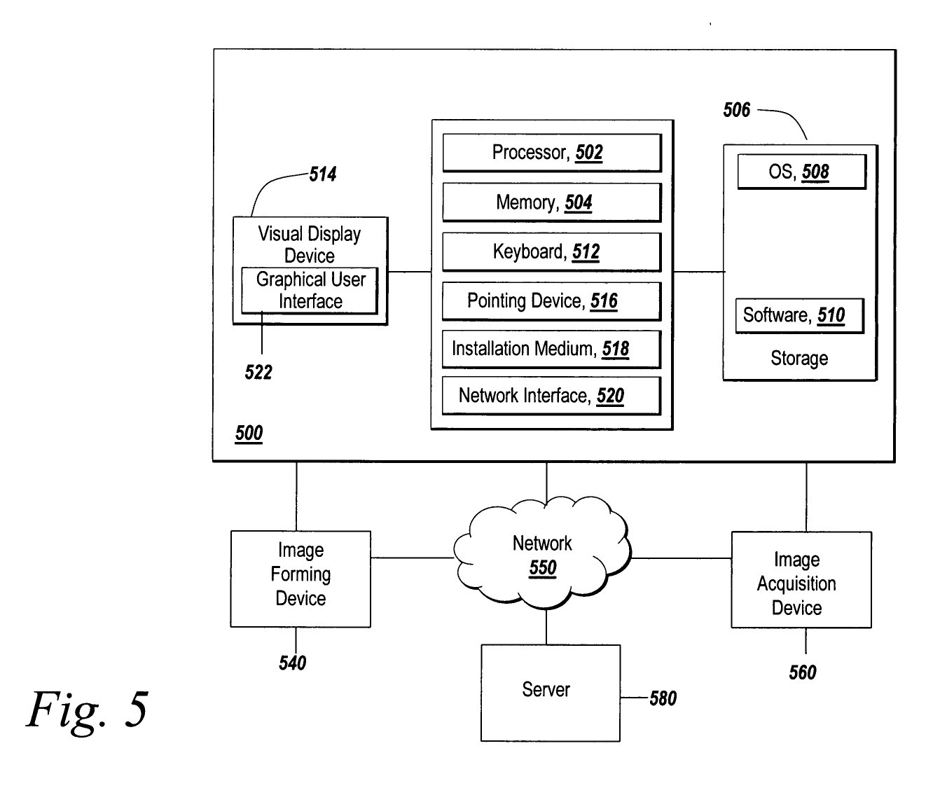

FIG. 5 illustrates a system suitable for formation of a decorative feature on a substantially soluble display medium in accordance with the teachings of the present invention. Nonetheless, those skilled in the art will appreciate that the formation of the decorative feature on a surface of the substantially soluble display medium is accomplishable with a number of techniques and methodologies. In one method, the decorative feature is formed with a computer device 500.

The computer device 500 includes memory 504, a visual display device 514, input devices such as a keyboard 512 and a pointing device 516, a processor (CPU) 502 for executing software stored in the memory 504, and other programs for controlling system hardware, a storage device 506 holding a software program 510 suitable for forming or creating a computer generated image on an image-forming device 540 such as an inkjet printer for use in forming the decorative feature on the substantially soluble display medium. A human user may interact with the computing device 500 through a visual display device 514 such as a computer monitor, which may be used to display a graphical user interface (GUI) 522.

The I/O devices such the keyboard 512 and the pointing device 516, for example a mouse, allow the computing device 500 to receive input from a user. Optionally, the keyboard 512 and the pointing device 516 may be connected to the visual display device 514. Additionally, the computing device 500 may include any type of input device for receiving user input, such as a joystick. In other embodiments, the computing device 500 may include any type of haptic or tactile feedback device, such as a vibration generating mouse, or a force feedback device such as a force feedback joystick. Also, the computing device 500 may include any type of sound producing I/O device such as any suitable sound card. The computing device 500 may include or be connectable to other suitable conventional peripherals like an image forming device 540 and an image acquisition device 560.

For installing software programs, the computing device 500 may support any suitable device readable medium 518, such as a CD-ROM, DVD-ROM floppy disks, tape device, USB device, hard-drive, or any other suitable device. The computing device 500 may further comprise a storage device 506, such as a hard-drive or CD-ROM, for storing an operating system 508 and other related software 510, for example, software for creating an image, software for editing an image, software such as a device driver for interfacing with an image forming device 540 and an image acquisition device 560 and other like software suitable for use in imaging a substantially soluble display medium in accordance with the teachings of the present invention.

Additionally, the computing device 500 may include a network interface 520 to interface to a network 550, including a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), cluster interconnection (Myrinet), peripheral component interconnections (PCI, PCI-X), wireless connections, or some combination of any or all of the above. In this manner, images suitable for use in imaging a substantially soluble display medium can be downloaded from a remote location such as a server 580. Additionally, the network interface 520 allows the computing device 500 to interface with a networked image forming device 540, a networked image acquisition device 560 or both. In this manner, the user of the computing device 500 can cooperatively work with one or more clients, contributors, collaborators and the like, that have network access. The network interface 520 may comprise a built-in network adapter, network interface card, PCMCIA network card, card bus network adapter, wireless network adapter, USB network adapter, modem or any other device suitable for interfacing the computing device 520 to any type of network capable of communication and performing the operations described herein.

Moreover, the computing device 500 may be any type and/or form of computer system such as a workstation, desktop computer, server, laptop, handheld computer or other form of computing or telecommunications device that is capable of communication and that has sufficient processor power and memory capacity to perform the operations described herein.

In operation, a user of the computing device 500 can create a decorative feature using a suitable program stored on the storage device 506 and instruct the computing device 500 to image the decorative feature using the image-forming device 540 onto the substantially soluble display medium. Typically, the image-forming device 540 images the decorative feature onto a surface of the substantially soluble display medium using an edible ink, for example, food coloring or other suitable edible ink, such as colored water, colored propylene glycol, colored or uncolored alcohol, and FD&C colors.

Additionally, the computing device 500 can communicate with the image acquisition device 560, such as an optical scanner capable of reading text or illustrations printed on a medium and translate the information into a form the computer system understands, a digital camera, video camera and other like image acquisition devices. In this manner, when the image acquisition device 560 has a structure, a function, and an operation of an optical scanner, a user can scan a desired decorative feature using the optical scanner into the computing device 500 and have the computing device 500 image the decorative feature onto the substantially soluble display medium using the image-forming device 540.

Another method suitable for forming a decorative feature on a surface of the substantially soluble display medium includes free hand formation of the decorative feature using pens or markers filled with edible ink, or brushes dipped in edible ink. Another suitable method for forming a decorative feature on a surface of the substantially soluble display medium includes screening of the decorative feature onto the surface using edible inks of colorings. Edible inks can be purchased from bakery wholesale companies. Those skilled in the art will appreciate that other methodologies and techniques are suitable for forming a decorative feature on a surface of a substantially soluble display medium in accordance with the teachings of the present invention, for example, a technique that combines use of the computer system and free hand methodologies to form a decorative feature.

In some embodiments, the edible inks used in connection the present invention are water-based. As used herein, “water-based inks” refer to inks which contain more water than non-aqueous solvent. Inks used in the present invention may also be solvent based. Inks may also be classified a non-pigmented and pigmented. Both may be used in the substantially soluble display media of the present invention.

Water-based non-pigmented inks generally include water and a soluble dye. Water-based non-pigmented inks suitable for use in connection with the present invention include, but are not limited to those available under product numbers CI 15050-D, CI 10572-D, and CI 12022-D, available from Colorcon, Inc., West Point, Pa. Another series of ink-jet printing inks is commercially available from PhotoFrost Decorating Systems, Blytheville, Ariz. In some embodiments, it is desirable to print on an edible surface using pigmented inks which, e.g., provide greater color opacity or less bleeding into the consumable liquid product. Preferred water-based pigmented inks include water (e.g., deionized water) and particulates (pigments). Such inks can require a means of keeping the pigments dispersed, as known in the art. Water-based pigmented inks may also contain some non-aqueous solvents. Water-based pigmented inks may optionally contain one or more dyes.

Exemplary inks suitable for use in connection with the present invention are known in the art and can be found, for example, in U.S. Pat. Nos. 3,258,347, 2,948,626, 3,694,237 and 4,543,370. These patents are incorporated herein by reference. Additional inks can also be used. For example, disappearing/appearing inks may also be used (e.g., those that will change, lose or acquire color when subjected to a property of the drink such as heat or alcohol content).

It is to be understood that the present invention is in no way limited by the actual decorative feature placed on the substantially soluble display medium, if any. That is, any image can be placed on the substantially soluble display medium of the present invention. Such images include, but are not limited to, company logos, trademarks, trivia questions, digital photo images, written words, prose, poetry, holiday greetings, cartoon characters or any other decorative feature.

In some embodiments, the substantially soluble display medium of the present invention comprises one or more additional agents. For example, the substantially soluble display medium can include flavoring agents, coloring agents, vitamin powders, bioluminescent dyes, and/or pharmaceutical powders. Suitable flavoring agents for use with the present invention include, but are not limited to essential oils and extracts, vanilla, hazelnut, chocolate, caramel, almond, peppermint, spearmint, chamomile, fruit extracts (e.g., strawberry, peach, raspberry, lemon, lime and banana), and spices or spice extracts (e.g., cinnamon, ginger and nutmeg). Exemplary coloring agents include, but are not limited to edible food colorings. Exemplary vitamin powders include, but are not limited to vitamin E or its esters, vitamin A or its esters, vitamin B, vitamin B1, vitamin B2, vitamin B3, vitamin B6, vitamin B12, B-complex, vitamin C, vitamin D, vitamin E, vitamin K, or any precursors or mixtures thereof. The substantially soluble display medium of the present invention may also include nutrients or minerals such as green tea extracts. Exemplary bioluminescent dyes include, but are not limited to, bioluminescent-generating systems such as luciferin-type and luciferase-type systems. Such systems are described, for example, in U.S. Pat. No. 6,113,886, the contents of which are incorporated in their entirety by this reference. Exemplary pharmaceutical agents include, but are not limited to, antibiotics, antivirals, anesthetics, antipsychotics, antifungals, steroidal and non-steroidal anti-inflammatory drugs, antioxidants, synthetically or naturally derived antidepressants, tranquilizers, decongestants, antiemetics, and antihistamines. The pharmaceutical agents can be prescription or non-prescription medication. Preferably the pharmaceutical is suitable for oral administration.

A skilled artisan would readily understand which additional agents will be used to provide a desired effect. For example, where the substantially soluble display medium is used in a malt alcoholic beverage, the skilled artisan would understand that adding, e.g., a flavoring agent would change the flavor of the beverage, which may or may not be desired. Alternatively, where a pharmaceutical agent is used in the substantially soluble display medium, it may be undesirable to use the substantially soluble display medium in an alcoholic beverage. Amounts and use of any and all additional agents can be modified readily based upon intended use. Additionally, the additional agents may be incorporated into the substantially soluble display medium or the ink in the decorative feature.

The present invention is also directed to a kit comprising the substantially soluble display medium of the present invention and instructions for using said display medium. The substantially soluble display medium may be imaged with a decorative feature, or not imaged. The kit may further comprise additional components including, but not limited to, one or more edible ink pens, markers, printer ink, inkjet cartridges including edible ink, cookie cutters to alter shape, punches to alter shape and/or stencils for imaging. The instructions may include, but are not limited to directions on how to use the substantially soluble display medium, directions on which consumable liquid product is appropriate for use with the specific packaged display medium, and/or directions for forming a decorative feature on the substantially soluble display medium.

### EXEMPLIFICATION

The present invention will now be illustrated by the following Examples, which are not intended to be limiting in any way.

### Example 1

### Methylcellulose Display Medium

18 ml of METHOCEL® (Dow Chemical Co., Midland, Mich.) is combined with about 2.67 ounces water at between about 177° F. and about 194° F. until the METHOCEL® is completely dissolved. An additional 5.33 ounces (approximately) of water at room temperature is added so that the total water in the composition is about 8 ounces. 1 ml glycerin and a quarter of a teaspoon of cornstarch are then added to the water/cellulose composition and the entire composition is agitated for about twenty minutes. The heated and agitated composition is then spread across a cooling means to cool and dry for about 24-26 hours.

### Example 2

### Potato Display Medium (Prospective)

Dehydrated potatoes (40% by weight) are combined with an amount of water (about ⅓ of total water used) at between about 177° F. and about 194° F. until the potatoes are dissolved. An additional amount of water at room temperature is added so that the total water in the composition is about 40% by weight of the composition. 20% vegetable oil by weight is then added to the water/potato composition and the entire composition is agitated for about twenty minutes. The heated and agitated composition is then spread across a cooling means to cool and dry for about 24-26 hours. Glycerin can also be added prior to agitation.

### Example 3

### Garnishing a Beverage

A decorative feature (e.g., a smiling face) is selected on a computer and formed on the methylcellulose display medium formed in Example 1 with a printer. The substantially soluble display medium is then added to a beverage (hot or cold). The unprinted portion of the substantially soluble display medium blends in with the beverage leaving the decorative feature visible on the surface. FIGS. 2 and 3 are representative images of garnishing a hot or cold beverage with an exemplary display media of the present invention.

Prospective: A decorative feature will be formed on the potato display medium with a printer, or alternatively with an ink pen by hand. The substantially soluble display medium will then be added to a hot or cold beverage. The unprinted portion of the substantially soluble display medium will blend in with the beverage leaving the decorative feature visible on the surface.

Prospective: A decorative feature will be formed on a substantially soluble display medium of the present invention. The substantially soluble display medium will then be added to the surface of soup. The unprinted portion of the substantially soluble display medium will blend in with the soup or ice cream leaving the decorative feature visible on the surface. FIG. 4 is a representative diagram of soup garnished with an exemplary display media of the present invention.

### EQUIVALENTS

While the invention has been shown and described with reference to selected embodiments, it should be understood by those skilled in the art that various changes in form and detail may be made therein without departing in spirit and scope of the invention as defined by the following claims. For example, the edible soluble display medium can be formed with other methodologies and other techniques without departing from the intended scope of the present invention.

What is claimed is:

1. A method for garnishing a consumable liquid product held by a container, the method comprising:
selecting a substantially soluble display medium comprising
an edible quasi-transparent component having a selected shape and dimensionality; and
an edible non-transparent component imaged on a surface of the quasi-transparent component to form a decorative feature; and
placing the substantially soluble display medium on a surface of the consumable liquid product to garnish the consumable liquid product.

2. The method of claim 1, wherein the decorative feature includes one of a text character, a numerical character, an image, a color, or a pattern.

3. The method of claim 1, wherein the substantially soluble display medium is buoyant.

4. The method of claim 1, wherein the substantially soluble display medium is soluble without agitation or heat.

5. The method of claim 1, wherein the substantially soluble display medium is soluble with agitation or heat or both.

6. The method of claim 1, wherein the substantially soluble display medium does not substantially absorb a liquid component of the consumable liquid product.

7. A method for manufacturing a substantially soluble display medium, the method comprising:
providing a substantially soluble edible composition;
forming the substantially soluble edible composition into a first selected shape having a first dimensionality; and
drying the first selected shape to form the substantially soluble display medium

8. The method of claim 7, further comprising forming a selected decorative feature on a surface of the substantially soluble edible composition.

9. The method of claim 7, further comprising forming the substantially soluble display medium into a second selected shape having a second dimensionality.

10. An imaged substantially soluble display medium, comprising
an edible quasi-transparent component having a selected shape and dimensionality; and
an edible non-transparent component imaged on a surface of the quasi-transparent component to form a decorative feature.

11. The display medium of claim 10, wherein the decorative feature includes one of a text character, a numerical character, an image, a color, or a pattern.

12. The display medium of claim 10, wherein the quasi-transparent component comprises a water soluble component.

13. The display medium of claim 10, wherein the substantially soluble display medium is buoyant.

14. The display medium of claim 10, wherein the quasi-transparent component comprises at least one member selected from the group consisting of methylcellulose, ethylcellulose, propylcellulose, and hydroxycellulose.

15. The display medium of claim 10, wherein the quasi-transparent component comprises a potato or potato-like product.

16. The display medium of claim 10, wherein the substantially soluble display medium does not substantially absorb liquid.

17. A method for garnishing a consumable liquid product, the method comprising:
selecting a substantially soluble display medium;
forming a decorative feature on a surface of the substantially soluble display medium; and
placing the substantially soluble display medium on a surface of the consumable liquid product to garnish the consumable liquid product.

18. The method of claim 17, where the substantially soluble display medium is in direct contact with the surface of the consumable liquid product.

19. The method of claim 17, where the substantially soluble display medium is in indirect contact with the surface of the consumable liquid product.
